(19) United States
(12) Patent Application Publication
(10) Pub. No.: US 2006/0212211 A1
(43) Pub. Date: Sep. 21, 2006

(54) Engine control device for construction machine

(75) Inventors: Yoshiki Kamon, Hiroshima (JP); Koichi Mitsugi, Hiroshima (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KOBELCO CONSTRUCTION MACHINERY CO., LTD., HIROSHIMA-SHI (JP)

(21) Appl. No.: 10/544,779

(22) PCT Filed: Jan. 14, 2004
(86) PCT No.: PCT/JP04/00200

§ 371 Date: Aug. 8, 2005

(30) Foreign Application Priority Data
Feb. 17, 2003 (JP) 2003-38869

(51) Int. Cl. F02D 17/04

(52) U.S. Cl. 701/112

(57) ABSTRACT

An engine control device for a construction machine of the present invention is configured so that an engine is automatically stopped by an engine controller under the condition that a remote control valve is not operated, an allowance time has passed and a gate lever for opening and closing a gateway for an operator is opened, and in which an average value of the last gate lever opening times is obtained and the allowance time is automatically set based on the average value.

### TECHNICAL FIELD

The present invention relates to an engine control device for a construction machine including a function for automatically stopping an engine.

### BACKGROUND ART

A construction machine including an automatic stop function for automatically stopping an engine when predetermined automatic stop conditions (for example, a gate lever for opening and closing a gateway to a cabin is opened and a lever for operating a work actuator is in non-operation) are met has been disclosed in Japanese Patent Laid-Open Nos. 2000-96627 and 2001-41069.

Further, when an engine is stopped at the same time when automatic stop conditions are established, even in a case where an operator temporarily leaves a car for short time business or meeting for example, the engine is automatically stopped and inconvenience that subsequent restarting operation is troublesome occurs. Thus a technique has been proposed in which allowance time is provided and an engine is stopped under AND conditions of the establishment of the automatic stop conditions and the lapse of allowance time.

This allowance time is defined as a fixed value, by using a time that is empirically considered to be necessary before operator's restarting a work.

However, since an appropriate allowance time is actually changed by a personality of an operator, a work environment, a change of operators or the like, there occurred problems that too long allowance time increases a useless engine operation time and on the contrary too short allowance time often requires restarting.

It is an object of the present invention to provide an engine control device for a construction machine, which can automatically and appropriately set an allowance time used for an automatic stop control.

### DISCLOSURE OF THE INVENTION

To solve the above-mentioned problems, the present invention adopted the following configurations.

The present invention comprises an engine as a power source, power unnecessary state detecting means for detecting a power unnecessary state that the engine power is unnecessary, and engine control means for automatically stopping the engine when the power unnecessary state is detected by the power unnecessary state detecting means and a predetermined allowance time has passed. The engine control means is configured so that the allowance time is automatically set to a shorter level if a power unnecessary degree as actual result is high in accordance with the past actual result of the power unnecessary degree, which shows a degree where the power unnecessary state occurred.

### BRIEF DESCRIPTION OF THE DRAWINGS

FIG. 1 is a block diagram showing a first embodiment of the present invention;

FIG. 2 is a flow chart for explaining contents of an automatic stop control according to the first embodiment;

FIG. 3 is a flow chart for explaining an automatic setting action of an allowance time according to the first embodiment;

FIG. 4 is a timing chart showing relationships between opening/closing of a gate lever and rotation/stop of an engine in the first embodiment;

FIG. 5 is a flow chart for explaining an automatic setting action of an allowance time according to a second embodiment of the present invention;

FIG. 6 is a timing chart showing relationships between opening/closing of a gate lever and rotation/stop of an engine in the second embodiment;

FIG. 7 is a flow chart for explaining an automatic setting action of an allowance time according to a third embodiment of the present invention;

FIG. 8 is a timing chart showing relationships between opening/closing of a gate lever and rotation/stop of an engine in the third embodiment;

FIG. 9 is a flow chart for explaining an automatic setting action of an allowance time according to a fourth embodiment of the present invention;

FIG. 10 is a timing chart showing relationships between opening/closing of a gate lever and rotation/stop of an engine in the fourth embodiment;

FIG. 11 is a flow chart for explaining an automatic setting action of an allowance time according to a fifth embodiment of the present invention; and

FIG. 12 is a flow chart for explaining an automatic setting action of an allowance time according to a sixth embodiment of the present invention.

### BEST MODE FOR CARRYING OUT THE INVENTION

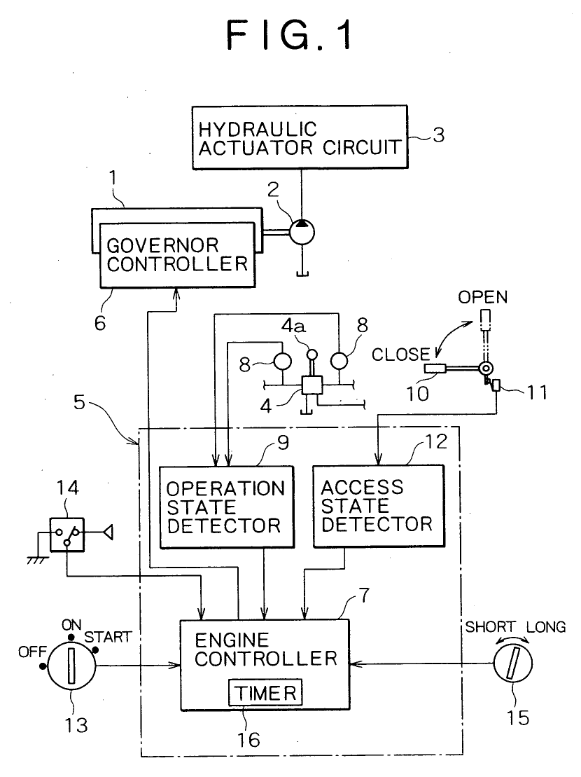

### First Embodiment (see FIGS. 1 to 3)

In FIG. 1, the reference numeral 1 denotes an engine as a power source. By this engine 1 a hydraulic pump 2 is driven and a discharge oil of the pump 2 is supplied to a hydraulic actuator circuit 3.

Reference numeral 4 denotes a remote control valve (an operating member), which has a lever 4a. A control valve (not shown) in the hydraulic actuator circuit 3 is switched and operated by a remote control pressure in accordance with the operation direction and amount of operation of this lever 4a so that an operation direction and a speed of a hydraulic actuator of a hydraulic cylinder, a hydraulic motor or the like are controlled.

A controller 5 is provided with an engine controller 7 as engine control means for controlling operation/stop of the engine 1 through a governor controller 6, an operation state detector 9 as operation state detecting means for detecting whether the remote control valve 4 is operated or not by signals from pressure sensors 8, 8 provided in the remote control valve 4 (operation state), and an access state detector 12 as access state detecting means for detecting an access state (opening and closing states of a gate lever) by a signal from a gate lever switch 11 for turning ON (operating state) when a gate lever 10 for opening and closing a gateway for the operator is opened from a closed state shown by a solid line to a state shown by broken lines in FIG. 1 (during the operator's leaving).

It is noted that when a machine of a canopy structure having no cabin has alternative means of the gate lever, an access state is detected by the fact that this alternative means is operated. For example, in a case where an operating lever box provided with an operating lever is liftable and lowerable and it takes such a configuration that the operating lever box is lowered at the seating of the operator, the access state is detected by lifting and lowering the operating lever box.

Reference numeral 13 denotes an engine switch for controlling start/stop of the engine 1 and ON/OFF of a power source, reference numeral 14 denotes a release switch for releasing an allowance time setting function by the engine controller 7 which will be described next, reference numeral 15 denotes a trimmer for manually setting a degree of the allowance time by the operator in a state where the allowance time setting function is released by this release switch 14.

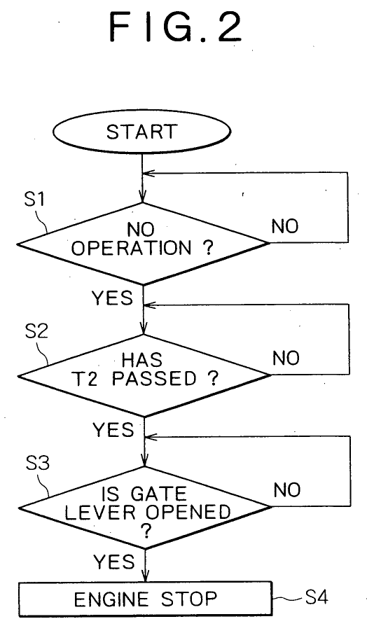

Contents of an automatic stop control by the engine controller 7 will be described with reference to FIG. 2.

It is determined whether or not the remote control valve 4 is in non-operation based on a signal from an operation state detector 9 as soon as a control is started (Step S1). In a case where the remote control valve 4 is operated (in a case of NO in Step S1), since an engine power is necessary, the processing flow does not advance to the following step.

On the other hand, in a case where the remote control valve 4 is not operated (no signal from the operation state detector 9, in a case of YES in Step S1), it is determined whether an allowance time T2 has passed or not in Step S2, and whether the gate lever 10 has been opened or not in Step S3. When both Steps S2 and S3 are YES, the engine 1 is automatically stopped in Step S4.

The operation state detector 9 and the gate lever 10 detect whether the power of the engine 1 is unnecessary or not.

Further, the engine controller 7 is provided with a timer 16. A power unnecessary time is measured by this timer 16 for every time when a power unnecessary state as a state where the power of engine 1 is unnecessary is generated. The power unnecessary time is stored in a memory unit (not shown).

The allowance time T2 until the engine is stopped at the following power unnecessary time is defined based on an average value of the last power unnecessary times stored in this memory unit.

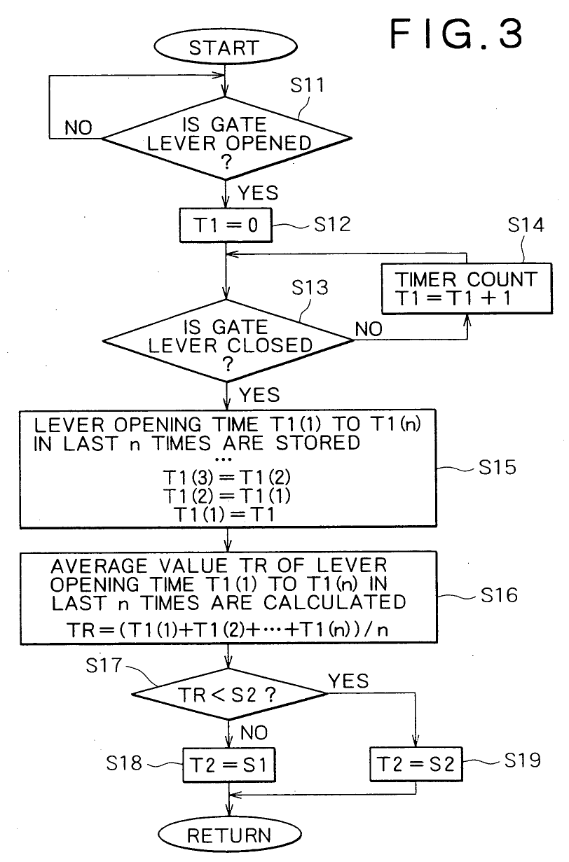

An automatic setting action of the allowance time T2 will be described with reference to FIG. 3.

First, it is determined whether the gate lever 10 is opened or not in Step S11 in a state where the remote control valve 4 is in non-operation. If the answer is YES in Step S11, a timer count value T1 is cleared (T1=0) in Step S12. A time (power unnecessary time) T1 required until the gate lever 10 is closed, that is, until the answer reaches YES in Step S13, is counted by the timer 16 (Step S14).

Next, the last n-times power unnecessary time T1 is stored in Step S15, an average value TR of the last n-times power unnecessary time T1 is calculated in Step S16 and an allowance time T2 is obtained based on this average value TR in Steps S17 to S19.

Namely, a short time reference value S1 (for example 30 seconds) and a long time reference value S2 (for example 10 minutes) with regard to allowance time are predetermined in the engine controller 7.

These reference values S1 and S2 are values, which are empirically considered as standard times in cases where the power unnecessary time is short and long respectively, and are appropriately set based on a work environment or the like.

In Step S17, it is determined whether or not the average value TP is less than the reference value S2 (TP<S2). In a case of NO (TR≧S2), the power unnecessary time is a long time of the reference value S2 or more as the past actual result. Accordingly, since the allowance time is too long, the allowance time T2 is set to S1 in Step S18 next time as the engine 1 should be stopped early.

On the other hand, in a case of YES (TR<S2) in Step S17, the power unnecessary time is a short time less than the reference value S2 as the past actual result. Accordingly, since the allowance time is too short, the allowance time T2 is set to S2 in Step S19 next time as the engine 1 should be stopped slowly.

Thus, the allowance time T2 used in Step S2 of an automatic stop control shown in FIG. 2 is set based on the last actual result and is renewed.

As explained above, the engine controller 7 is configured so that if a degree (power unnecessary degree) of generation of power unnecessary state is high, the engine controller 7 automatically sets (adjusts) the allowance time T2 to become shorter in accordance with the past actual result of the generation of power unnecessary state in the engine 1. Here the allowance time T2 is calculated and used as a function of the power unnecessary degree.

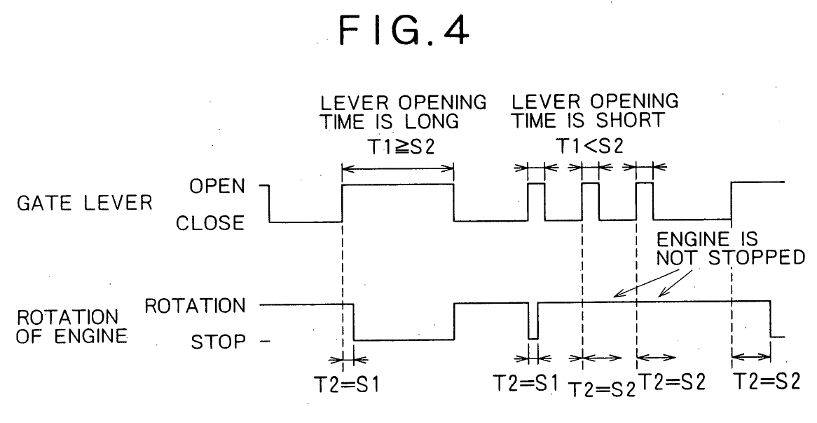

FIG. 4 shows engine rotation/stop states at the allowance time T2 set as described above. In a case of T2=S1, the gate lever 10 is opened and the engine is stopped after S1. In a case of T2=S2, the gate lever 10 is opened and the engine is stopped after S2.

As a result, it is highly likely that a predetermined allowance time T2 is the right appropriate value strongly reflecting the personality of the operator and the work environment. Thus, an essential object of having an allowance time which is to save fuel cost or the like by stopping the engine early when an opening time T1 of a gate lever is long, and to remove a trouble of restarting the engine by waiting for a long time until the engine is stopped when the opening time T1 of a gate lever is long as shown in FIG. 4 can be attained.

Particularly, since the allowance time T2 is based on the average value TR, the longer a use time of a machine becomes, the more a predetermined allowance time matches the actual situation. Thus the allowance time enhances an accuracy of an appropriate value.

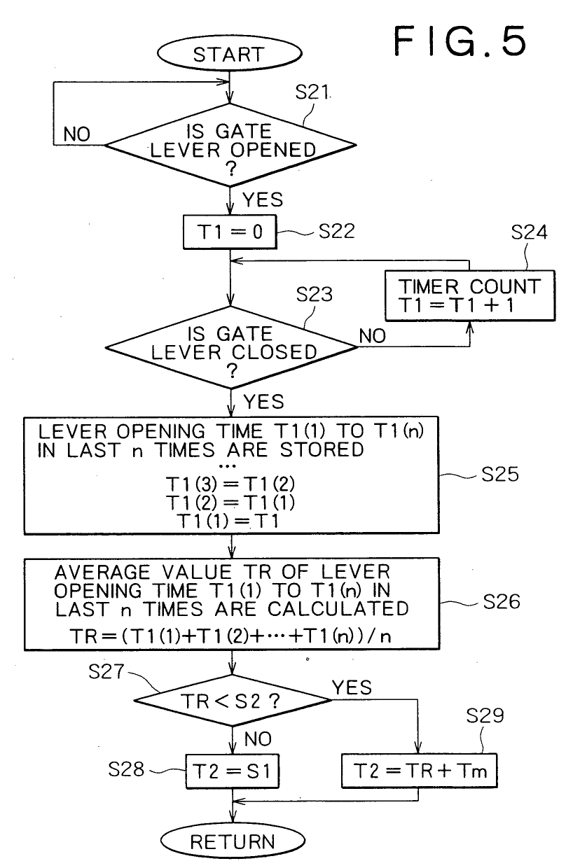

### Second to Fourth Embodiments (see FIGS. 5 to 10)

Only different points between the first embodiment and second to fourth embodiments will be described below. It is noted that since apparent configurations of the following embodiments are substantially the same as that of the first embodiment (FIG. 1), any configurations of the following embodiments use FIG. 1 and the respective drawings are omitted. Only flow charts and timing charts of opening/closing of a gate lever and rotation/stop of an engine are shown.

The second embodiment includes, as shown in FIG. 5, Steps S21 to S27, which are the same contents as Steps S11 to S17 in FIG. 3 according to the first embodiment. If TR<S2 is not satisfied (in case of NO in Step S27) in Step S27, Step S28 is set to be T2=S1. However, in a case of TR<S2, a predetermined margin Tm (for example 1 minutes) is added to TR so that T2 is set.

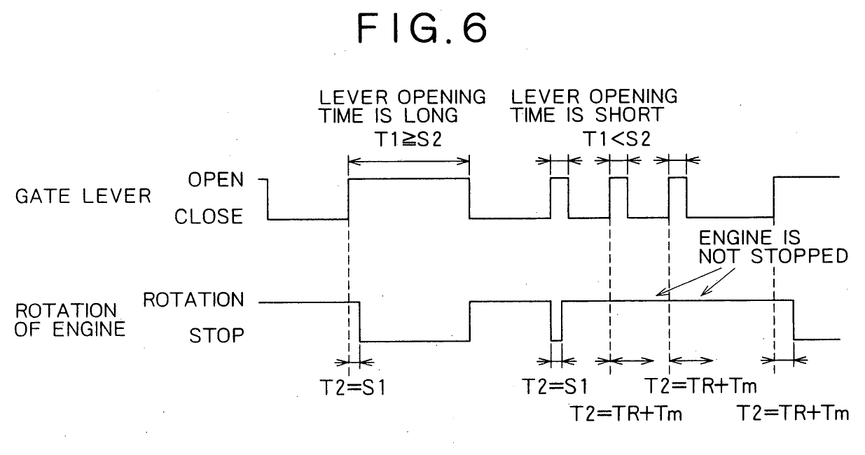

States of opening/closing of a gate lever and rotation/stop of an engine in such a setting are shown in FIG. 6.

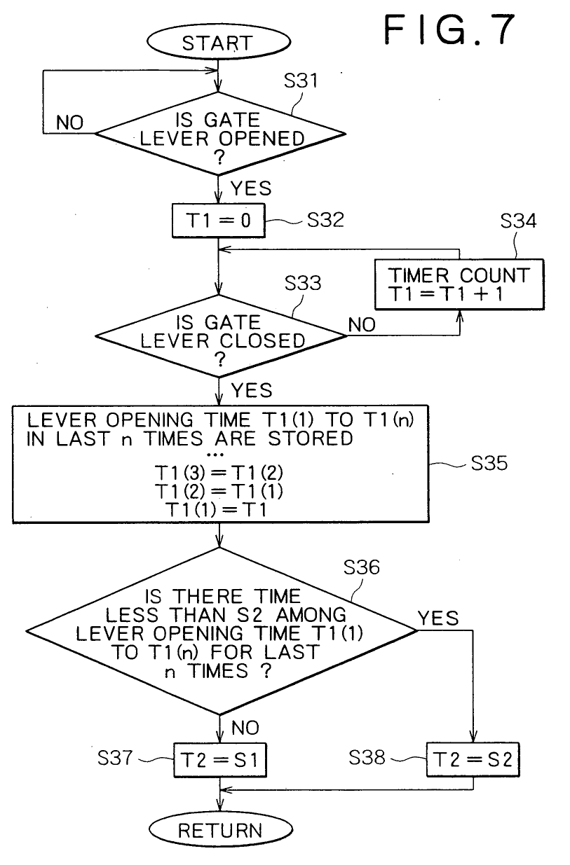

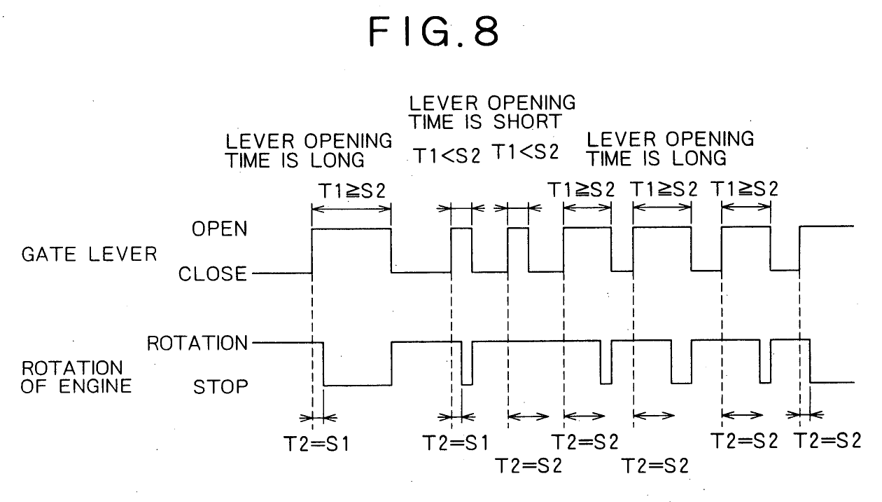

In the third embodiment, as shown in FIG. 7, it is determined whether or not there is a time which is less than the reference value S2 among the last n-times gate lever opening times T1(1) to T1(n) in step 36 after Steps S31 to S35, which are the same as Steps S11 to S15 in FIG. 3 according to the first embodiment. In a case where there is no such a time, step 37 is set to be T2=S1, and in a case where there is even once, step 38 is set to be T2=S2. These results are shown in FIG. 8.

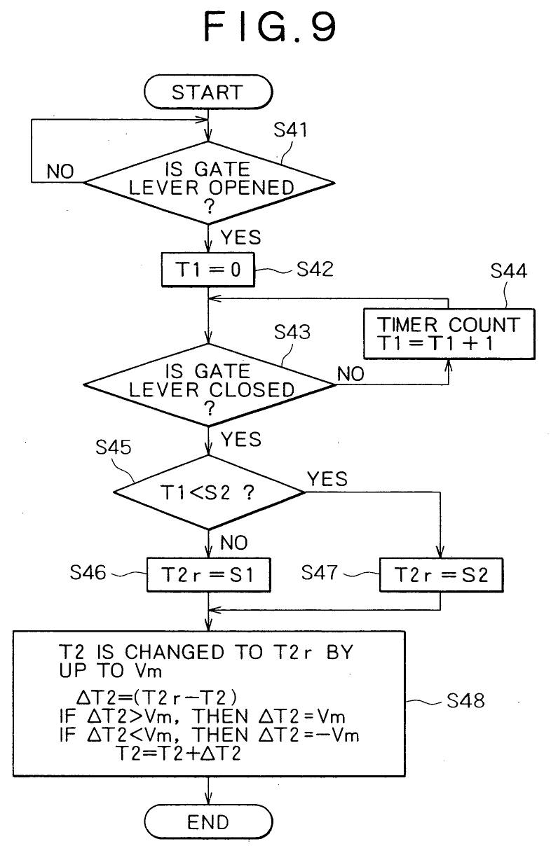

In the fourth embodiment, as shown in FIG. 9, after Steps S41 to S44, which are the same contents as Steps S11 to S14 in FIG. 3 according to the first embodiment, a gate lever opening time T1 and a long time reference value S2 are compared with each other in Step S45.

Here, if T1<S2 is not satisfied (in a case of NO in Step S45), a target value T2r of an allowance time is set to S1 in Step S46, and if T1<S2 is satisfied, the target value T2r is set to S2 in Step S47. Then, the allowance time T2 is varied by every Vm or less (for example, 10 seconds) to the target value T2r.

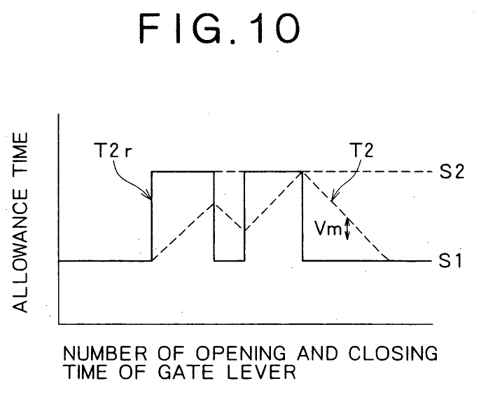

As a result, as shown in FIG. 10, the allowance time T2 is gradually changed to the target value T2r between Steps S1 and S2.

Even in the second to fourth embodiments if the gate lever opening time T1 is shorter than the reference value, the engine is stopped slowly, and if it is longer than the reference value, the engine is stopped early as in the first embodiment, and a useless operation and an unnecessary stop of the engine 1 can be basically avoided.

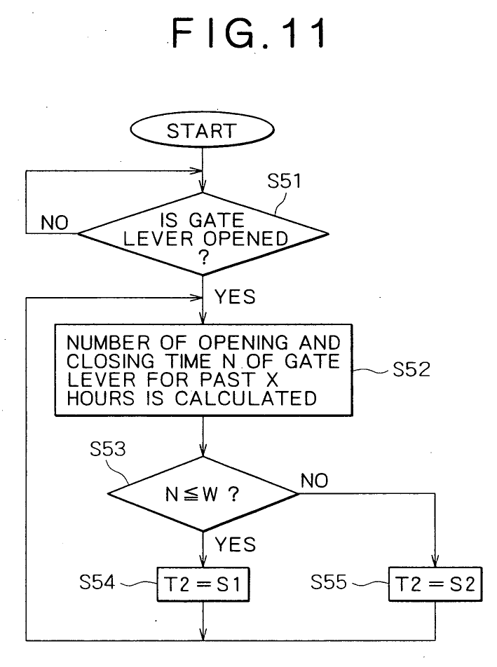

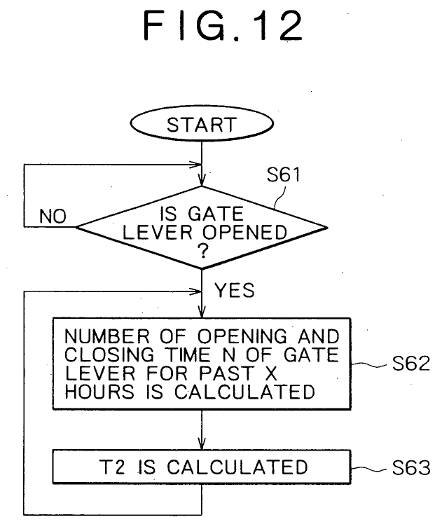

### Fifth and Sixth Embodiments (see FIGS. 11 and 12)

In the fifth embodiment, as shown in FIG. 11, after an opening of a gate lever the number of times N (frequency of power unnecessary state) of opening the gate lever 10 in the last X hours is calculated (Steps S51 and S52), and this calculated number of times N and a predetermined reference value W are compared with each other in Step S53.

The above-mentioned reference value W is a value, which is empirically considered as a standard lever opening number of times within X hours. In a case of N≦W, the number of times is a low frequency. Thus, Step S54 is set to be T2=S1 as the engine 1 should be stopped early. In the meanwhile, in a case of N>W, the number of times is a high frequency. Thus, Step S55 is set to be T2=S2 as the engine 1 should be stopped slowly.

On the other hand, in the sixth embodiment as shown in FIG. 12, after the opening of the gate lever, the gate lever opening number of times N is calculated within the last X hours (Steps S61 and S62). If the calculated number of times N is more than a predetermined value, an allowance time T2 is obtained as a function of N to increase T2 in Step S63.

Since in these fifth and sixth embodiments, the allowance time T2 is also set based on the past actual result as in the first to fourth embodiments, this allowance time T2 becomes a value suitable for a personality of an operator and a work environment.

### Other Embodiments

(1) As a variation of the first and second embodiment, a maximum value and a minimum value of gate lever opening times T1 in the last n-times are excluded and an average value TR may be obtained from the remaining numeral values.

(2) As another variation of the first and second embodiment, the allowance time T2 may be obtained as a function of the average value TR of gate lever opening times T in the last n-times.

(3) Although in the above-mentioned respective embodiments, as data of power unnecessary states the gate lever opening time T1 or the number of opening times N per unit hour are used, other data (for example, a time when the remote control valve 4 is not operated or its number of times) may be used.

### INDUSTRIAL APPLICABILITY

The present invention mentioned above has a configuration that an allowance time is obtained based on the past actual result of power unnecessary degrees reflecting an operator's preference and a work environment so that it is automatically set. Thus in comparison to the known technique in which a fixed value is used as the allowance time, according to the present invention, the right appropriate allowance times suitable for the operator's preference and the work environment are always set so that a useless engine operation and troubles of often restarting the engine can be minimized.

What is claimed is:

1. An engine control device for a construction machine characterized in that said engine control device comprises an engine as a power source, power unnecessary state detecting means for detecting a power unnecessary state that a power of said engine is unnecessary, and engine control means for automatically stopping said engine when the power unnecessary state is detected by said power unnecessary state detecting means and a predetermined allowance time has passed, and wherein said engine control means is configured so that, in accordance with a past actual result of a power unnecessary degree showing a generation degree of the power unnecessary state, said engine control means is adapted to automatically make said allowance time shorter, when said power unnecessary degree as said actual result is high.

2. The engine control device for a construction machine according to claim 1, wherein said engine control means is configured so that said allowance time is calculated as a function of the power unnecessary degree.

3. The engine control device for a construction machine according to claim 1, wherein said engine control means is adapted to measure a power unnecessary time by every generation of the power unnecessary state and to, in accordance with an average value TR relating said power unnecessary time among the last measured power unnecessary times, automatically make said allowance time shorter when the average value TR is long.

4. The engine control device for a construction machine according to claim 3, wherein said engine control means is adapted to predetermine a short time reference value S1 and a long time reference value S2 relating said allowance time, to automatically set said allowance time to the reference value S2 in a case of TR<S2 in relationship between the average value TR and the long time reference value S2, and to automatically set said allowance time to the reference value S1 in a case of TR≧S2.

5. The engine control device for a construction machine according to claim 3, wherein said engine control means is adapted to predetermine a short time reference value S1 and a long time reference value S2, to automatically set said allowance time to an average value TR and a given margin Tm in addition in a case of TR<S2, and to automatically set said allowance time to a reference value S1 in a case of TR>S2.

6. The engine control device for a construction machine according to claim 1, wherein said engine control means is adapted to predetermine a short time reference value S1 and a long time reference value S2 relating said allowance time while measuring power unnecessary time by every generation of the power unnecessary state, and wherein said engine control means is adapted to automatically set said allowance time to the reference value S2 when there is the measured power unnecessary time less than the reference value S2 among the last measured power unnecessary times and to automatically set said allowance time to the reference value S1 when there is none of the measured power unnecessary time less than the reference value S2 among said power unnecessary degree.

7. The engine control device for a construction machine according to claim 1, wherein said engine control means is adapted to predetermine a short time reference value S1 and a long time reference value S2 relating said allowance time while measuring power unnecessary times by every generation of the power unnecessary state, and said engine control means is adapted to set a target value T2r of said allowance time to a reference value S2 when the last power unnecessary time is less than the reference value S2 and to set said target value T2r to a reference value S1 when said last power unnecessary time is not less than the reference value S2 whereby the next allowance time is changed to the target value T2r.

8. The engine control device for a construction machine according to claim 1, wherein said engine control means is adapted to measure the number of the last power unnecessary state per unit hour and to automatically make, in accordance with the measuring number, said allowance time longer when the measured number is many.

9. The engine control device for a construction machine according to claim 8, wherein said engine control means is adapted to predetermine a short time reference value S1 and a long time reference value S2 relating said allowance time as well as a reference value W relating the number of the power unnecessary state per unit hour whereby the engine control means is adapted to automatically set said allowance time to the reference value S1 when the measured number N satisfies N<W and to automatically set said allowance time to the reference value S2 when the measured number N satisfies N≧W.

10. The engine control device for a construction machine according to claim 1, wherein said power unnecessary state detecting means is adapted to detect a state where a gate lever for opening and closing a gateway for an operator is opened as the power unnecessary state.

11. An engine control device for a construction machine characterized in that said engine control device comprises an engine as a power source, a gate lever for opening and closing a gateway for an operator, access state detecting means for detecting a closing or opening state of said gate lever by a signal from said gate lever, operation state detecting means for detecting whether or not an operating member is operated, and engine control means for automatically stopping said engine when a non-operation state of the operating member is detected by said operation state detecting means, a state where said gate lever is closed is detected by said access state detecting means, and a predetermined allowance time has passed, and that said engine control means is adapted to adjust the allowance time in accordance with a degree at which the non-operation state of the operating member is generated.
